(19) United States
(12) Patent Application Publication
(10) Pub. No.: US 2016/0366905 A1
(43) Pub. Date: Dec. 22, 2016

(54) METHOD FOR PRODUCING A COFFEE BEVERAGE

(71) Applicant: MELITTA PROFESSIONAL COFFEE SOLUTIONS GMBH & CO. K G, Minden (DE)

(72) Inventors: Thomas DIESTER, Bückeburg (DE); Kai HALLMANN, Minden (DE); Bernd BUCHHOLZ, Rahden (DE)

(73) Assignee: MELITTA PROFESSIONAL COFFEE SOLUTIONS GMBH & CO. KG, Minden (DE)

(21) Appl. No.: 15/187,775

(22) Filed: Jun. 20, 2016

(30) Foreign Application Priority Data
Jun. 22, 2015 (DE) 10 2015 109 921.7

(51) Int. Cl. A23F 5/26; A47J 31/36

(52) U.S. Cl. CPC A23F 5/26; A47J 31/3671

(57) ABSTRACT

A method for producing a coffee beverage, using ground coffee in a brewing chamber of a coffee machine including a control unit and a brewing cylinder housing a movably arranged piston having a piston drive for providing a changeable volume for the brewing chamber. An amount of ground coffee is filled into the brewing chamber. Water is conduct through the ground coffee in the brewing chamber to prepare the coffee beverage. A volume flow of water flowing through the brewing chamber is determined and compared to a desired value for the volume flow. An adjustment value of the piston position is changed, thus changing the pressing force exerted onto the ground coffee, in the brewing chamber as a function of deviations from the desired value for the volume flow to control the volume flow until a desired volume flow is reached.

### CROSS-REFERENCE TO RELATED APPLICATIONS

This application claims priority to German Application No. 10 2015 109 921.7 filed Jun. 22, 2015, the disclosure of which is incorporated by reference in its entirety.

### BACKGROUND OF THE INVENTION

The invention relates to a method for producing a coffee beverage. Fresh coffee beverages can be produced with different methods, for example with the aid of piston—coffee machines (so-called specialty machines). With piston-brewing machines, the total amount of coffee and/or beverage is conducted under high pressure through a brewing unit.

German patent documents DE 36 07 656 C2, DE 10 2004 056 224 A1, DE 10 2009 012 970 A1 and published International Patent Application No. WO 2011/045055A1 disclose technological background with respect to the present invention.

In particular, WO2011/045055 A1 discloses a method for producing a coffee beverage which uses a specified amount of ground coffee, a brewing process in a coffee machine with a control unit and a brewing cylinder with a therein arranged movable piston, provided with a piston drive, to result in a changeable volume of the brewing chamber and thus the pressure on the materials inside the brewing chamber, wherein the brewing process involves at least the following steps:
an amount of ground coffee is filled into the brewing chamber;
water is conducted through the brewing chamber filled with ground coffee to brew the coffee, wherein a volume flow, in particular the volume of water flowing through the brewing chamber, is determined as the control variable and is compared to a desired volume flow value;
upon reaching a desired volume of the brewed coffee beverage, the brewing process is ended.

The known methods have proven successful per se, but a further optimizing of the taste and aroma of the coffee beverage is desirable. In particular, the coffee beverage taste is reduced as a result of a decreasing volume flow through the brewing chamber, especially in the second half of the brewing process.

### SUMMARY OF THE INVENTION

It is an object of the present invention to solve the above described problem.

The above and other objects are accomplished according to one embodiment by a method for producing a coffee beverage using ground coffee in a brewing chamber and a brewing operation in a coffee machine including a control unit and a brewing cylinder housing a movably arranged piston having a piston drive for providing a changeable volume for the brewing chamber, wherein the method includes: filling an amount of ground coffee into the brewing chamber; conducting water through the ground coffee in the brewing chamber to prepare the coffee beverage; determining a volume flow of water flowing through the brewing chamber; comparing the determined volume flow of water to a desired value for the volume flow; and changing an adjustment value of the piston position and thus the pressing force exerted onto the ground coffee in the brewing chamber as a function of deviations from the desired value for the volume flow to control the volume flow until a desired volume flow is reached.

In particular, according to the above-described embodiment, the volume flow is controlled with the aid of a quality control circuit that monitors the volume flow of coffee that is dispensed. This method results in optimizing the coffee taste and/or the aroma because it avoids a reduction in the coffee taste and aroma as a result of a reduced flow, in particular during the second half of the brewing process.

The invention therefore provides a method for preparing a coffee beverage for which the extraction behavior during the preparation is optimized, and the quality of the coffee beverage is improved.

The piston position determines the pressure exerted onto the ground coffee and/or the mixture of ground coffee/water in the brewing chamber. By changing the piston position, the size of the brewing chamber and thus also the pressure on the ground coffee can be changed.

The volume flow may be controlled during the brewing operation such that the volume flow remains constant during the complete brewing operation. Constant volume flow is defined herein to mean that the volume flow changes as little as possible, meaning preferably by no more than 10 percent during the brewing operation. Thus, a value is preferably stored as a constant for the volume flow of each different type of coffee beverage (espresso, café crême etc.), wherein the discharge volume is influenced through influencing the piston position. However, it is also conceivable to suitably change the volume flow gradually or even toward the end of the brewing operation, for example to increase volume flow to influence the coffee taste in a desired manner.

To realize the inventive method, the continuous influence exerted on the volume flow during the brewing operation may be measured.

According to one embodiment, the volume flow control variable is determined with the aid of an impeller as a measuring device. An impeller is a cost effective device that is sufficiently precise for the purpose of the herein required control. The impeller may be arranged upstream of the brewing chamber, in particular in the water intake for the brewing chamber. The position of the piston, on the one other hand, may be used as the controlling element. If the pressing force is computed for a position determination, the characteristic of the ground coffee should also be considered when determining the piston position to be adjusted. The control can therefore be calibrated in dependence on the grinding capacity and the type of coffee bean used. In this way, a grinding fineness and temperature dependent constant dispensing time and/or contact time can be ensured very easily in the later concept which, in turn, advantageously contributes to optimizing the coffee beverage taste.

When preparing espresso as the coffee beverage, for example, a constant dispensing speed of approximately 3 to 4 ml/s has turned out to be especially advantageous for a tested type of coffee. By contrast, a dispensing speed of between 18 and 20 ml/s is advantageous for the preparation of a café crême.

A separate dispensing speed and/or a separate volume flow value for each type of coffee beverage may be stored in a database and/or in a memory of a computer unit of a coffee machine.

For double cans and mixed products, for example, different volume flows can be defined as ideal and can be stored. Furthermore, it is possible to define the definition of the desired profile course for various volume flow variables for different product types, distinguished by an especially positive influence on the coffee quality.

Additionally, a combination of the inventive method with an automatic adjustment of the grinding capacity, may be realized independent of the grinding fineness, to keep this influencing parameter constant. However, an automatic adaptation to the grinding fineness is also conceivable.

Furthermore, it is conceivable to measure the cake height within the brewing unit. For this, the weighed portion and the grinding fineness of the grinder are determined, and the piston displacement and/or the pulses issued by the motor and/or the piston drive may be measured. In this way and using a corresponding comparison, conclusions can be reached with respect to the coffee cake height and the grinding capacity of the grinder which, in turn, permits an automatic determination and control of these parameters. In this way, a simplification of the grinder adjustment and/or the actuation is also conceivable.

One problem with the adaptation of the grinding fineness is an indirect, later and thus sluggish reaction to system variables. On the other hand, the resistance and thus the dispensing volume flow can be influenced strongly via the grinding fineness. This influence can be utilized in a system combination to set the quality control circuit automatically to an optimum adjustment range, for example to react to drastic changes in the conditions (change in the type of beans).

It is furthermore conceivable to differentiate this system for each individual client. For this, client-specific basic conditions can be determined and stored (e.g. type of beans, weighed portion, water amount and dispensing time). Following this, the grinding fineness for the preferred coffee beans and reference products (espresso and café crême) are determined and stored in the memory. This can be achieved with the aid of an impeller by measuring the cake height in the brewing chamber, as well as a dispensing volume flow.

If the volume flow repeatedly falls outside of a predetermined scope, a grinding fineness adaptation is initiated. This adaptation can occur either during the running grinding operation for a product preparation or as a separate referencing and independent process. The goal of this variant of the invention is to move the volume flow via a supplemental adaption of the grinding fineness again into a range in which the pressing forces can be used for the control.

The inventive method is may be combined with an automatic weighed portion control for determining, influencing and controlling the grinding amount.

Also, the inventive method may be supplemented with an automatic grinding fineness adaptation for adjusting the control circuit variable to an optimum functional range.

In a further embodiment, a product-related target profile volume flow may be determined and/or specified and managed and if constant dispensing volume flows are generated.

The system may also be used to compensate for pressure fluctuations in the system.

### BRIEF DESCRIPTION OF THE DRAWINGS

The invention is now explained in further detail in the following with the aid of exemplary embodiments and reference to the enclosed drawings.

FIG. 1 is a schematic block diagram of an exemplary embodiment of a coffee machine according to the invention.

FIG. 2 is a simplified flow chart of an exemplary embodiment of a method according to the invention.

### DETAILED DESCRIPTION OF THE INVENTION

The same references in the Figures denote the same components and/or functional units having the same functions.

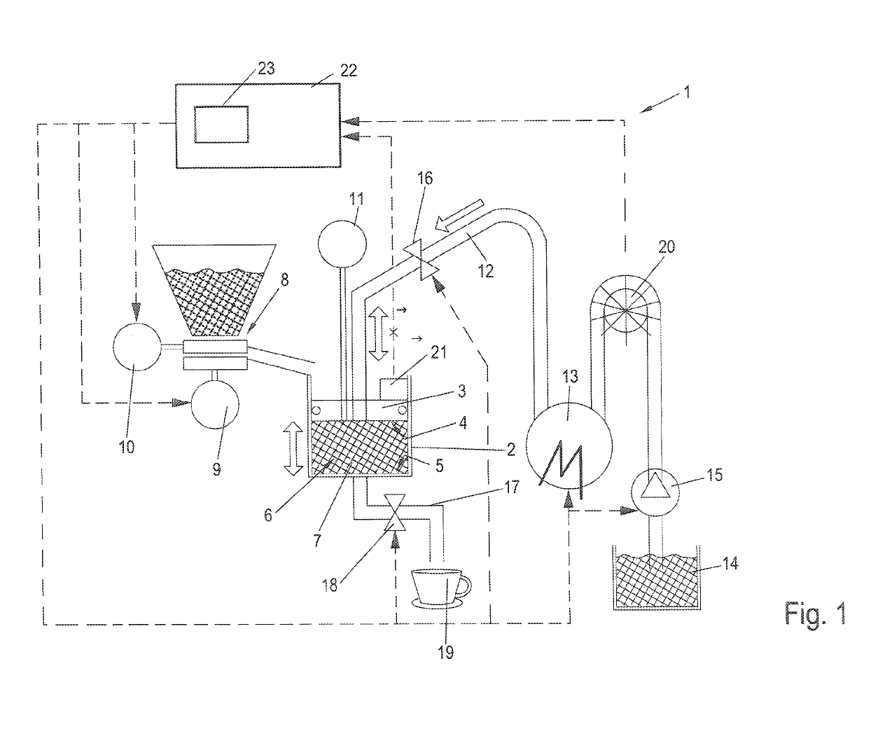

FIG. 1 is a schematic block diagram of an exemplary embodiment of a coffee machine 1 according to the invention, configured as a fully automatic and/or a piston machine.

The coffee machine 1 comprises a brewing group including a brew cylinder 2 and a piston 3 arranged movable therein as a pressing device. The actual brewing chamber 6 is embodied between an end face 4 of the piston 3 and an end face 5 of the brewing cylinder 2 that is arranged opposite the end face 4.

The brewing chamber 6 can be filled with ground coffee 7. This ground coffee 7 may be supplied by a grinder 8 following the grinding of coffee beans. The grinder 8 is provided with a grinding mechanism and preferably also with a device 10 for adjusting the grinding fineness. The ground coffee 7 can also be provided differently, for example in the form of portions surrounded by filter paper which can be inserted into the brewing chamber 6.

With the piston 3, pressure may be exerted onto the ground coffee inside the brewing chamber 6, so that it is compressed. The pressing force of the piston 3 can be varied with the aid of a piston drive 11, in particular a linear drive, which is coupled to the piston 3. With the piston drive 11, the piston 3 can be moved back and forth inside the brewing cylinder 2, in particular in an axial linear direction X (denoted by double headed arrow), to change the size of the brewing chamber 6 and thus the pressure exerted onto the material inside the brewing chamber 6.

At least one hot water unit is furthermore connected to the brewing chamber 6. This hot water unit has a water feed line 12 that is connected to the brewing chamber and also to the water heater 13 (boiler or flow-through heater or the like). From the water heater 13, water can be supplied through a line or from a container 14 via a pump 15 to the brewing chamber 6 and conducted through this chamber. The hot water may be forced through an opening in the piston 3 into the brewing chamber 6. For this, a hot water valve and/or a brewing valve 16 is installed in the water supply line 12. The actual preparation of the coffee beverage takes place in the brewing chamber 6 when hot water is supplied to the ground coffee 7.

The brewing cylinder 2 is embodied as a strainer in the region of the end face 5 which also delimits the brewing chamber 6. The coffee exiting the strainer of the brewing chamber 6 flows via a discharge line 17 with therein installed discharge valve 18 into a vessel, in particular a cup 19.

The water volume per time unit, meaning the volume flow, which is pumped by the pump 14 and/or is conducted through, can be measured with at least one measuring device 20, preferably embodied as an impeller 20 herein. This volume flow essentially corresponds to the volume flow of the coffee beverage flowing out of the brewing chamber.

At least one device is advantageously provided for detecting or determining the position of the piston 3, which can be embodied as displacement sensor 21 or alternatively, for example, as a device for the position determination from the number of steps of a step motor arranged as a piston drive 11.

The operation of the coffee machine is controlled and regulated by a control unit 22 with user interface 23, in particular an input device for entering data and an output device for displaying information. A control and regulating program is executed in this control unit 22. One or preferably several profiles (from which the user can select) are stored in the control unit, which respectively correspond to a coffee beverage to be prepared. For each coffee beverage, at least the amount of ground coffee to be filled into the brewing chamber and the water volume to be conducted through the brewing chamber are stored ahead of time for the selected coffee beverage. To be stored ahead of time are preferably one or several of the following additional parameters: degree of grinding fineness, water temperature, if applicable the amount of cold water to be added.

The control unit 22 is advantageously connected to all or in any case all essential electrically activated and/or evaluated components of the coffee machine. A volume flow information and a piston position information, in particular, are available as input information for the control unit 22. The control unit 22 is furthermore provided with the information concerning the amount of ground coffee to be filled into the brewing chamber, wherein the grinding fineness of the ground coffee is preferably also available to the control unit. The water temperature is furthermore also known and is obtained from sensors to be queried (not completely shown herein) or from information in the form of a control preset at the corresponding units.

The following exemplary embodiment describes the preparation of a coffee beverage according to the invention.

For the preparation of a coffee beverage, a desired amount of ground coffee 7 is initially provided by the grinder or other storage device to the brewing chamber 6. For this, the grinder 8 is activated via the control unit 22, in particular by selecting the grinding fineness and activating the grinder drive 9.

As soon as the brewing chamber 6 is filled with the desired amount of ground coffee, the piston 3 is moved to a desired starting position for the brewing process, wherein the control unit 22 activates the piston drive 11 for this, and coffee is then prepared in the brewing chamber 6 by conducting water through the ground coffee and dispensed therefrom. For this, the control unit 22 activates at least the brewing valve 16 and the pump 15, as well as preferably the water heater 13, and the discharge valve 18 which is opened.

The brewing occurs during a specified time interval, controlled by the control unit 22, to which is respectively supplied the information from the volume measuring device 20 concerning the flowthrough volume per time unit at the measuring device.

Once a predetermined amount of water flows through the brewing chamber 7, the brewing process is stopped.

To optimize the brewing process, the goal is to control the volume flow of dispensed coffee, which essentially and/or nearly corresponds to the volume flow of water at the measuring device. In particular, this volume flow is kept constant, preferably by using the piston position as adjustment variable to regulate and/or influence the volume flow.

The process is controlled insofar by suitably adjusting and/or changing the piston 3 position in the brewing cylinder 2. The piston 3 position can be changed by activating the piston drive 11.

If the piston position is not changed during a brewing process, the volume of water flowing per time unit through the brewing chamber still changes since the characteristics of the ground coffee 7 in the brewing chamber 6 change during the course of the brewing process. As a result, the flow resistance for the water flowing during the brewing operation through the brewing chamber 6 increases during the course of the brewing operation, so that with a constant position of the piston 3 the water volume decreases that flows per time unit through the brewing chamber 6.

Based on the findings resulting in the invention, it is advantageous to counteract in particular this effect, wherein this is achieved easily by determining the actual variable for the “volume flow” and using it as a control variable. The adjustment variable in this case is the position of the piston 3 in the brewing chamber 6.

The control functions as follows: the piston 3 in the brewing chamber 6 is pulled back somewhat as soon as a limit value stored in the control unit (preferably in dependence on a previously stored profile) for the volume (volume per time unit) flowing through the brewing chamber 6, which is detected by the measuring device 20, exceeds a limit value. As a result, the brewing chamber volume is increased and the pressure on the ground coffee in the brewing chamber is decreased. With a constant pump speed and constantly opened brewing valve 16, the water volume flow per time unit in the brewing chamber 6 is thus increased.

The prepared coffee flows through the outlet valve 18 into the cup 19.

The compressed cake composed of coffee grounds is then removed from the brewing chamber 6 to a container, and the brewing chamber 6 is readied for a new preparation.

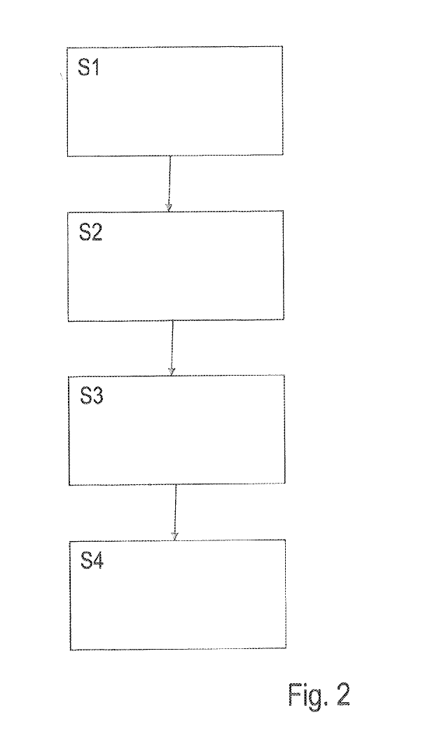

FIG. 2 shows a simplified flow chart of an exemplary embodiment of a method according to the invention for preparing a coffee beverage using the above-described coffee machine.

The preferred method for preparing a coffee beverage therefore involves the following steps:
S1: In a first method step S1, a specified amount of ground coffee is poured into the brewing chamber 6.
S2: In a second method step S2, a coffee beverage is prepared using the supplied, specified amount of ground coffee and brewing it in the brewing chamber 3. In the process, a volume flow, in particular a water volume flow through the brewing chamber, is determined as the control variable.
S3: In case of deviations from a predetermined desired volume flow value, the piston position functioning as adjustment variable is controlled in a third method step 3, such that the specified desired volume flow value is reached.

Steps S2 and S3 are continuously repeated and/or executed until a specified volume flow is reached, at which point the beverage preparation is stopped (step S4).

It is furthermore conceivable either after or parallel to a preparation process to add fresh, cold water from the cold water intake to the concentrate to reach a desired beverage amount.

The invention is not limited to the above-described exemplary embodiments but can be modified within the scope of the enclosed claims.

It will be understood that the above description of the present invention is susceptible to various modifications, changes and adaptations, and that the same are intended to be comprehended within the meaning and range of equivalents of the appended claims.

What is claimed is:

1. A method for producing a coffee beverage using ground coffee in a brewing chamber and a brewing operation in a coffee machine including a control unit and a brewing cylinder housing a movably arranged piston having a piston drive for providing a changeable volume for the brewing chamber, wherein the method includes at least the following method steps:
filling an amount of ground coffee into the brewing chamber;
conducting water through the ground coffee in the brewing chamber to prepare the coffee beverage;
determining a volume flow of water flowing through the brewing chamber;
comparing the determined volume flow of water to a desired value for the volume flow; and
changing an adjustment value of the piston position and thus the pressing force exerted onto the ground coffee in the brewing chamber as a function of deviations from the desired value for the volume flow to control the volume flow until a desired volume flow is reached.

2. The method according to claim 1, wherein the conducting and comparing are executed repeatedly during the brewing operation.

3. The method according to claim 2, including stopping the brewing operation once a desired volume of the brewed coffee beverage is reached.

4. The method according to claim 1, including maintaining the desired value for the volume flow constant during the brewing operation

5. The method according to claim 1, including changing the value of the desired volume flow during the brewing operation.

6. The method according to claim 1, including storing different preparation profile datasets in a memory of the control unit for preparing different coffee beverages, wherein the pre-stored data of each dataset includes, respectively, at least one pre-stored desired volume flow value.

7. The method according claim 1, including mathematically determining the desired volume flow value from parameters of the respective brewing process to be realized.

8. The method according to claim 1, including utilizing a grinding fineness and the amount of ground coffee in the brewing chamber as additional parameters in the determination of the desired volume flow value.
